(19) United States
(12) Patent Application Publication
(10) Pub. No.: US 2026/0288738 A1
(43) Pub. Date: Sep. 24, 2026

(54) COMPUTER SYSTEM AND METHOD FOR NATURAL LANGUAGE INSPECTION OF ARTIFACT HITS IN A DIGITAL FORENSIC SYSTEM

(71) Applicant: Magnet Forensics Inc., Waterloo (CA)

(72) Inventors: Jad John Saliba, Waterloo (CA); Mark Thistle, Ottawa (CA); Xinwei Chen, Ottawa (CA); Jan Wichanski, Waterloo (CA); Alex Duong, Waterloo (CA); Justin Franchetto, Waterloo (CA)

(21) Appl. No.: 19/573,705

(22) Filed: Mar. 20, 2026

Related U.S. Application Data
(60) Provisional application No. 63/775,731, filed on Mar. 21, 2025.

(51) Int. Cl. G06F 16/2457; G06F 16/248

(52) U.S. Cl. CPC G06F 16/24578; G06F 16/248

(57) ABSTRACT

Systems and methods for searching a digital forensic evidence data store in a data storage device using artificial intelligence are provided. The method includes receiving a user query from a user in natural language via a graphical user interface, generating an artifact filter from the user query using retrieval augmented generation (RAG), searching the digital forensic evidence data store using the artifact filter to find artifacts that are semantically relevant to the user query, and displaying the found artifacts in the graphical user interface. The method may include using a first large language model (LLM) to generate the artifact filter and a second LLM to generate a natural language response based on the found artifacts. The natural language response may be displayed with the found artifacts in the user interface.

### TECHNICAL FIELD

The following relates generally to digital forensics, and more particularly to systems and methods for inspecting artifact hits in a digital forensics system using machine learning techniques.

### INTRODUCTION

Digital forensics requires the analysis of very large datasets to identify files and other data with potential evidentiary value. While software exists for processing digital forensic datasets, existing techniques can still place a significant burden on the human investigator user to manually review large datasets and identify or document relevant data (or “hits”).

Existing solutions tend to use traditional data storage such as relational databases, which limit searching across records to Keyword searching (requiring an exact match). This can take time as the user has to filter down the evidence, trying to find the correct keywords to use to sort through data (e.g., did a conversation or email use the term gun, or pistol, or weapon).

Accordingly, there is a need for an improved system and method for analyzing digital forensic datasets that overcomes at least some of the disadvantages of existing systems and methods.

### SUMMARY

A method of searching a digital forensic evidence data store in a data storage device is provided. The method is executed by one or more processors in communication with the data storage device. The method includes: receiving a user query from a user in natural language via a graphical user interface; generating an artifact filter from the user query using retrieval augmented generation (RAG); searching the digital forensic evidence data store using the artifact filter to find artifacts that are semantically relevant to the user query; and displaying the found artifacts in the graphical user interface.

In an embodiment, the method further includes generating a natural language response to the user query based on the found artifacts using a large language model (LLM) and displaying the natural language response with the found artifacts.

In an embodiment, the found artifacts are displayed as structured data citations.

In an embodiment, the structured data citations each include a link to original digital forensic evidence in the digital forensic evidence data store corresponding to the artifact.

In an embodiment, generating the artifact filter includes generating generic data query steps and transforming the generic data query steps into an application-specific filter structure, and searching the digital forensic evidence data store using the artifact filter includes executing the application-specific filter structure against the digital forensic evidence data store.

A system of searching a digital forensic evidence data store in a data storage device is also provided. The system includes a memory comprising at least one storage device and one or more processors in communication with the memory. The one or more processors are configured to: receive a user query from a user in natural language via a graphical user interface; generate an artifact filter from the user query using retrieval augmented generation (RAG); search the digital forensic evidence data store using the artifact filter to find artifacts that are semantically relevant to the user query; and display the found artifacts in the graphical user interface.

In an embodiment, the one or more processors are further configured to generate a natural language response to the user query based on the found artifacts using a large language model (LLM) and display the natural language response with the found artifacts.

In an embodiment, the found artifacts are displayed as structured data citations.

In an embodiment, the structured data citations each include a link to original digital forensic evidence in the digital forensic evidence data store corresponding to the artifact.

In an embodiment, generating the artifact filter includes generating generic data query steps and transforming the generic data query steps into an application-specific filter structure, and searching the digital forensic evidence data store using the artifact filter includes executing the application-specific filter structure against the digital forensic evidence data store.

A digital forensics system is also provided. The system includes a data storage device and a processor in communication with the data storage device. The processor includes a digital forensic data processing application and an artifact inspection application. The digital forensics data processing application is configured to extract forensic artifacts from a primary forensic dataset and store the forensic artifacts in a database in the data storage device. THe artifact inspection application is configured to (i) receive a natural language query from a user through a user interface requesting inspection of the forensic artifacts, (ii) inspect the database based on the natural language query to identify relevant forensic artifacts from the forensic artifacts in the database using retrieval augmented generation (RAG), and (iii) output the relevant forensic artifacts for display in the user interface.

In an embodiment, inspecting the database includes converting the user prompt into an artifact filter using an artifact filter generation module comprising a large language model (LLM), and the artifact filter is used by an artifact filtering module of the digital forensics data processing application to obtain the relevant forensic artifacts from the database.

In an embodiment, the artifact inspection application uses a first large language model (LLM) to generate an artifact filter from the user query for filtering the relevant forensic artifacts from the forensic artifacts and a second LLM to generate a natural language response to the user query based on the relevant artifacts.

In an embodiment, the artifact inspection application displays the relevant artifacts and the natural language response in the user interface.

In an embodiment, the artifact inspection application uses a large language model to generate a set of structured generic data queries from the user query, and the digital forensics data processing application transforms the set of structured generic data queries into an application-specific filter structure for searching the database and executes the application-specific filter structure against the database to obtain the relevant forensic artifacts.

In an embodiment, the artifact inspection application creates a large language model (LLM) prompt to deconstruct the user query into relevant artifact domains that are further processed against domain schema.

In an embodiment, inspecting the database includes converting the user prompt into an artifact filter using a large language model (LLM). The artifact filter includes a set of structured generic data queries and an application specific filter structure. The artifact inspection application transforms the set of structured generic data queries into the application specific filter structure. The digital forensics data processing application executes the application specific filter structure against the database to obtain the relevant forensic artifacts.

In an embodiment, inspecting the database includes using a large language model (LLM) to extract a set of generic data queries that correspond to the user query.

A non-transitory computer-readable medium is also provided. The non-transitory computer-readable medium stores computer-executable instructions which, when executed by a computer processor cause the computer processor to receive a user query from a user in natural language via a graphical user interface; generate an artifact filter from the user query using retrieval augmented generation (RAG); search the digital forensic evidence data store using the artifact filter to find artifacts that are semantically relevant to the user query; and display the found artifacts in the graphical user interface.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a flow diagram of a method of scanning digital forensics evidence from a user query supplied in natural language using natural language processing (NLP), according to an embodiment;

FIG. 2 is a flow diagram of a method of using a large language model (LLM) to extract data queries relevant to an original user query utilizing select system instructions, according to an embodiment;

FIG. 3 is a block diagram of a computer system for reviewing target device digital evidence, according to an embodiment;

FIG. 4 is a block diagram of a data processing pipeline for natural language inspection of artifact hits in a digital forensics system according to an embodiment;

FIG. 5 is a block diagram of the artifact filter generation module of FIG. 4, according to an embodiment;

FIG. 6 is a block diagram of the natural language processing (NLP) response generation module of FIG. 4, according to an embodiment;

FIG. 7 is an example graphical user interface screen displaying an example output of the data processing pipeline of FIG. 4, according to an embodiment;

FIG. 8 is a block diagram of a computer system for natural language inspection of artifact hits in a digital forensic system, according to an embodiment; and

FIG. 9 is a schematic diagram of a digital forensics computer system, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to digital forensics, and more particularly to systems and methods for inspecting artifact hits in a digital forensics system using artificial intelligence (AI) or machine learning (ML) techniques.

The systems and methods of the present disclosure use novel storage and retrieval mechanisms such as Retrieval Augmented Generation (RAG) that uses Semantic Search to find relevant evidence that is semantically similar to a user's question. Then, to make reviewing the found evidence faster, the system answers the user's question with a Large Language Model (LLM) along with the evidence found via RAG.

This approach speeds up time to evidence by assisting the user with answers to their questions that traditionally would take considerably more time as the user filters down the evidence, trying to find the correct keywords to use to sort through data. For example, in traditional systems a user may have to search to see if “gun”, or “pistol”, or “weapon” was used, while in the present disclosure a user may search for “weapon” and find all of those words and more.

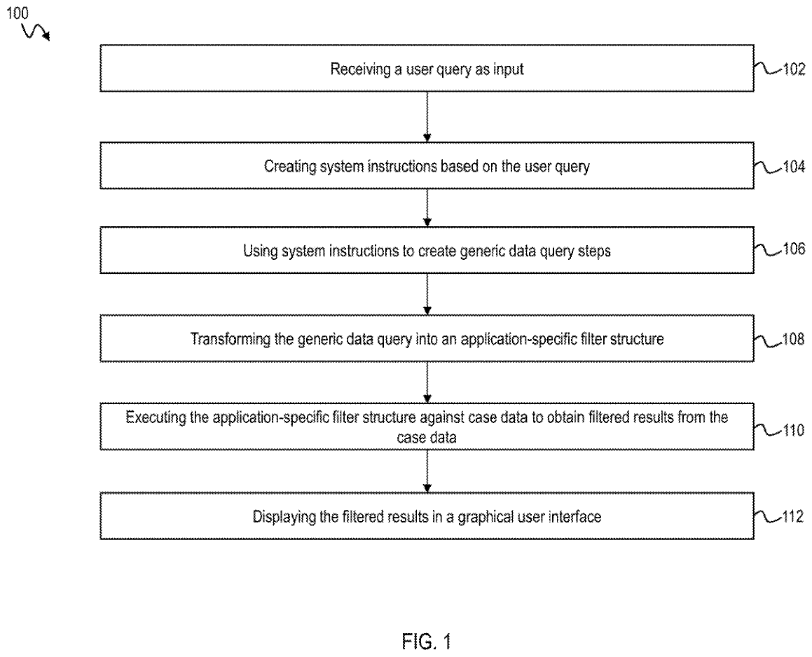

Referring now to FIG. 1, shown therein is a method 100 of scanning digital forensics evidence from a user query supplied in natural language using natural language processing, according to an embodiment. The method 100 may be used to search a target dataset (also referred to as case data) for forensically relevant artifacts.

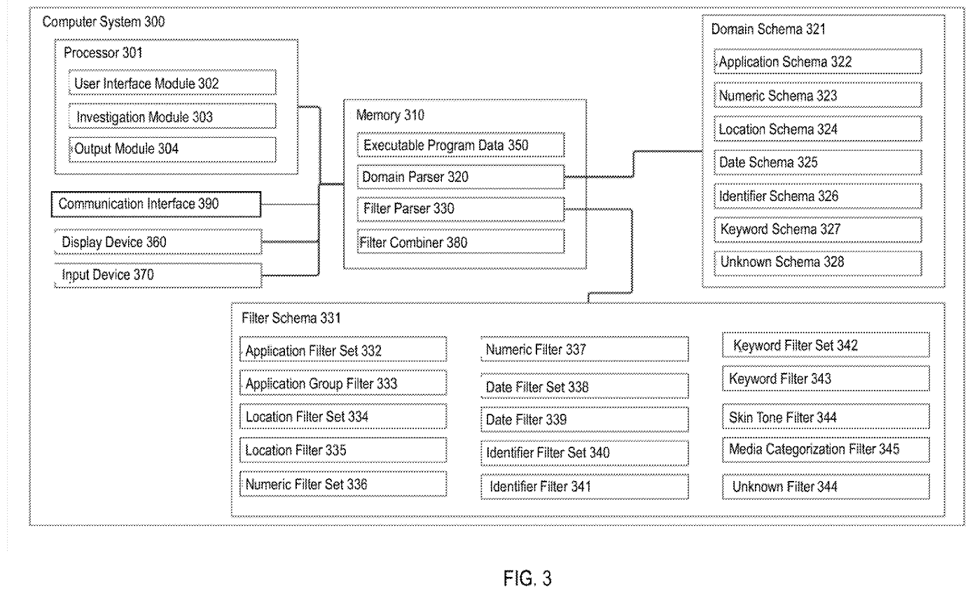

The method may be encoded as computer-executable instructions stored in memory and which, when executed by one or more processors, cause the one or more processors to perform the method 100. The method 100 may be executed by the computer system 300 of FIG. 3, described herein.

Method 100 and any of its variants may be implemented using hardware, software or any suitable combination thereof. When implemented in software, the software may execute on any suitable processor or collection of processors, whether stand-alone or networked. The software may be stored as processor-executable instructions and configuration parameters; such software may be stored on one or more non-transitory, tangible computer-readable storage media.

Software implementing process 100 may be organized in any suitable manner. For example, it may be organized as a software system comprising one or more software modules such that each software module may perform at least a part of one or more acts of process 100.

Though, in some embodiments, one or more software modules of such a software system may perform functions not related to acts of process 100, as aspects of the present disclosure are not limited in this respect.

At 102, the method 100 includes receiving a user query as input.

At 104, the method 100 includes creating system instructions based on the user query from 102. For example, a user query of “show me all photos taken within 100 miles of Ottawa, ON” may be turned into a system instruction that includes: Search all Images; For each image with GPS data; Show the images that fall within the GPS bounding box of the 100 miles around Ottawa, ON, Canada.

This includes the creation of an LLM prompt to deconstruct the user query into relevant artifact ‘domains’ that are further processed against domain schema.

An artifact domain is a grouping of evidence by a similar family of artifacts. Example artifact domains may include: Conversations; Email; Documents; Images; Videos; Web; System Events.

The domain schema defines an artifact domain, the parts of a Natural Language Question that map to the artifact domain, and what the definition of the artifact domain is programmatically so it can be returned to the system for further processing and use as a filter.

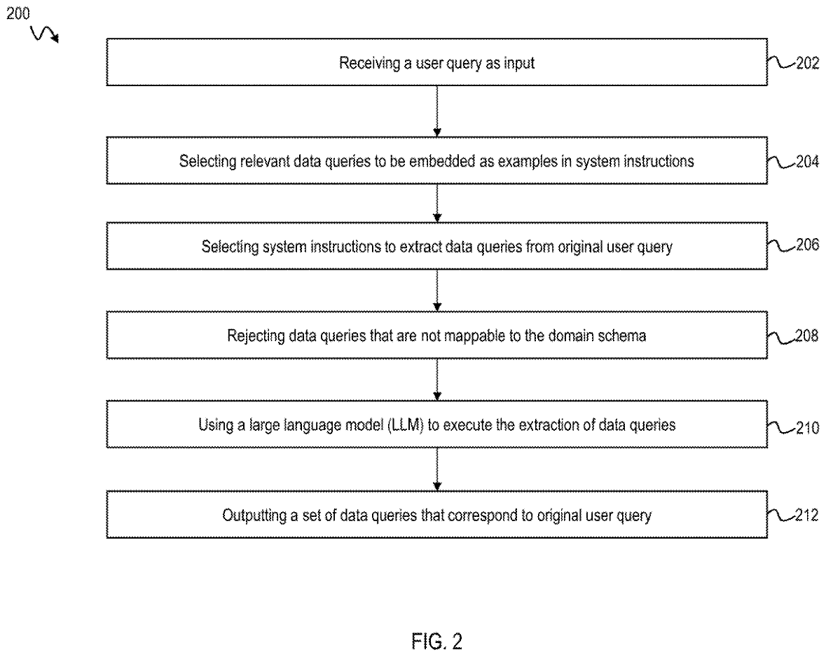

At 106, the method 100 includes using the system instructions from 104 to create generic data query steps. This process may be executed by an artifact filter generation module and is further described in FIG. 2, according to an embodiment.

In an embodiment, the system instructions in the form of the domain schema from the user query's natural language are fed back into the system with detailed information on each domain and the segment of the user's query that matches that domain. Here, domain refers to a specific area of natural language that corresponds to a filter that is of interest to a digital forensics investigator. Example domains include date/time, location, skin tone percentage (e.g., % of pixels in an image), artifact type, and keyword. This is then turned into a series of generic (non-application specific) query steps that are required to answer the user's question given a data store of digital forensics evidence. This is done because there is a first pass to split the user's query into high level domain with a domain schema. Then, the split segments and the detailed domain schemas for each domain are fed back into the system to turn each segment of the user's query into a step that could be used by a filter to find the evidence related to the user's query.

At 108, the method 100 includes transforming the generic data query steps from 106 into an application-specific filter structures.

Once a digital forensics data processing application (e.g., Magnet Forensics' Axiom Examine) receives the generic data query steps from the system, the application transforms that into a filter that is specific to its data store for how the application retrieves evidence from its data store (i.e., an application-specific filter structure). To use the example above, the application-specific filter structure may be something like:
(i) CaseId: <Case Identifier for case that the filter was created in>
(ii) FilterId: <Filter id for retrieving the filter later>
(iii) FilterItems: <list of application specific filter instructions>
(iv) Filter by Image
(v) Filter by Lat, Long Left Top Corner Bounding Box
(vi) Filter by Lat, Long Right Bottom Corner

At 110, the method 100 includes executing the application-specific filter structure against case data to obtain filtered results from the case data.

In an embodiment, filtered results, using the above query of “show me all photos taken within 100 miles of Ottawa, ON”, may be a user interface view in the digital forensics data processing application (e.g., Examine) that shows all picture images in the case that contain geolocation data that indicate the picture was taken within 100 miles of the center of Ottawa, Ontario.

At 112, the method 100 includes displaying the filtered results from 110 in a graphical user interface.

Referring now to FIG. 2, shown therein is a method 200 of using a large language model (LLM) to extract data queries relevant to the original user query utilizing select system instructions, according to an embodiment. The method 200 may be used to search a target dataset (also referred to as case data) for forensically relevant artifacts. The method 200 may correspond to step 106 of method 100 of FIG. 1.

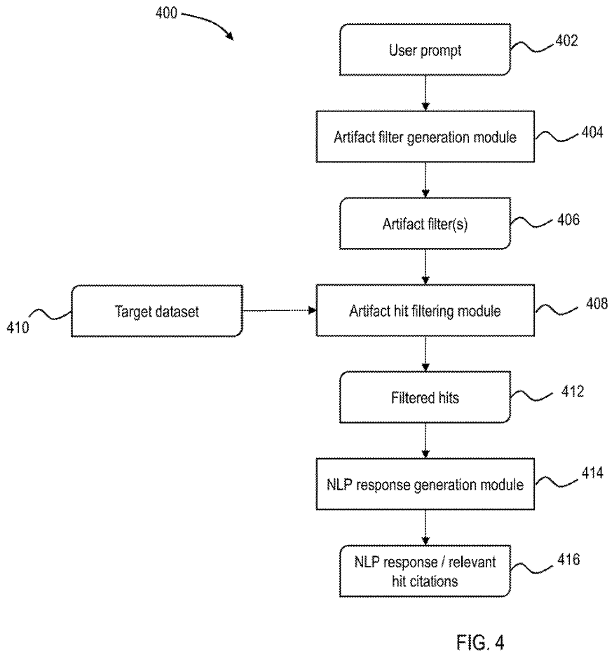

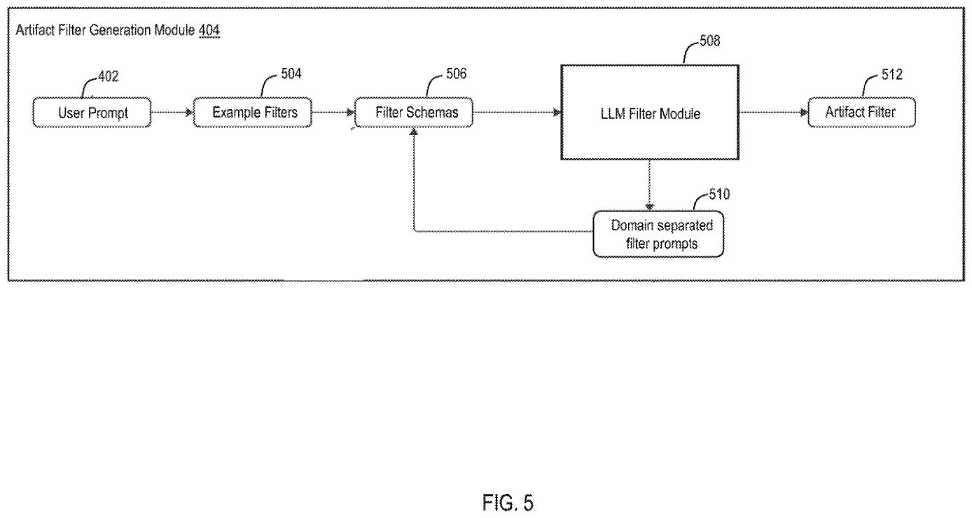

The method 200 may correspond to step 106 of FIG. 1. The method may be encoded as computer-executable instructions stored in memory and which, when executed by one or more processors, cause the one or more processors to perform the method 200. The method 200 may be executed by the computer system of FIG. 3, described herein. The method 200 may be executed by artifact filter generation module 404 of FIGS. 4-5.

Method 200 and any of its variants may be implemented using hardware, software or any suitable combination thereof. When implemented in software, the software may execute on any suitable processor or collection of processors, whether stand-alone or networked. The software may be stored as processor-executable instructions and configuration parameters; such software may be stored on one or more non-transitory, tangible computer-readable storage media.

Software implementing process 200 may be organized in any suitable manner. For example, it may be organized as a software system comprising one or more software modules such that each software module may perform at least a part of one or more acts of process 200.

Though, in some embodiments, one or more software modules of such a software system may perform functions not related to acts of process 200, as aspects of the present disclosure are not limited in this respect.

At 202, the method 200 includes receiving a user query as input. The user query may be an inputted user question. The user query relates to a target dataset that is being investigated. Generally, the user query is designed to try and identify forensic artifacts within the target dataset that may provide evidentiary value to the investigation.

At 204, the method 200 includes selecting relevant data queries to be embedded as examples in system instructions. Based on the user query from 202, example filter operations are selected to be included in system instructions to guide a Large Language Model (LLM) in the subsequent operations. In this case, the system instructions include a prompt that instructs the LLM on how to answer the user question.

The prompt include a section on context that is added in. The context is constructed from additional system instructions that tune the prompt and the context given the type of evidence that a question is being asked about.

For the filter operations, domain schemas may be used that are similar to those described above to add system instructions to the evidence lookup to retrieve just the evidence that fits into the high level domain schema that that filter operation detected. For example, a filter may be constructed that limits evidence retrieval to a class of artifacts (such as chats, images, websearch) and that limits the range of evidence that will be retrieved to anything within a specified time range (if supplied by the user in their query).

At 206, the method 200 includes selecting system instructions to extract data queries from the original user query. Based on the original query from 202 and relevant domain schemas, system instructions are constructed that will extract a generic data query from the user queries.

In the case of queries that go into an LLM, relevant domain schemas may include:
(i) Date Time Schema that take a user's natural language query that indicates a time range and then turns it into an actual time range. For example, a natural language query including “the 2 weeks around May 15, 2024” may then become May 1, 2024-May 30, 2024.
(ii) In the case where a user asks a question about a particular artifact type such as Photos, the Artifact Domain may translate that into a search filter for any evidence that is an image.

At 208, the method 200 includes rejecting data queries that are not mappable to the domain schema. If there are data queries that cannot be mapped to the domain schemas, such data queries are rejected or excluded from subsequent operations.

At 210, the method 200 includes using an LLM to execute the extraction of data queries. Using the original user query from 202, the examples, and the domain schemas in a single system instruction, the instruction is executed with the LLM to extract a structured answer to the user query along with a structured data citation.

In an embodiment, the LLM is based on the Transformer ML model. In general, a prompt is created that tells the LLM how to answer a user question including a zero shot example of sample context data and the expected answer for that context. Then, the real context data is supplied based on the system commands that retrieved the nearest matching evidence to their query. Finally, the query is supplied.

All of this is combined into a single prompt that instructs the LLM on how to answer the user query. The LLM uses the evidence context given to it to answer the question.

In an embodiment, this is achieved as follows. The prompt is converted into tokens. A token is a number where a word is usually made up of approximately 1.3 tokens per English word. So, 3000 English words are roughly 4000 tokens.

The tokens are then fed into the transformer ML model. Based on the training data used to train the LLM model, the transformer architecture applies meaning to the tokens and then attempts to answer the query in the tokens given the context of the prompt instructing the LLM on how to answer the query and using the context that was provided. In this case, the context contains evidence from a digital forensics case.

Different LLM models respond differently to the same tokens. Part of building the prompt instructions and context format is testing against multiple LLMs to find one that best can answer the style of question that users are expected to ask of digital forensics evidence. For example, a model that can follow instructions in the prompt is preferable to a coding model designed for answering just questions about code.

The data queries are a citation that is structured as a data query that the calling application can apply to its local data store of digital forensics evidence. For example, when the system retrieves the digital evidence that is used to build the context of evidence that is injected into the prompt that is passed into the LLM, this context may include a client hit ID to the original evidence that was uploaded from the client (the digital forensics data processing application, e.g., Axiom Examine). The client ID is the identifier that the client uses as the lookup ID for the original digital forensics evidence.

So, the generic data query is a citation that includes the text associated with the digital forensics evidence and the ID back to the original digital forensics evidence artifact within the client application's digital forensics evidence data store.

At 212, the method 200 includes outputting a set of generic data queries that correspond to the original user query. In this case, the generic data query is a generic record that includes a “client ID” and the “text” associated with a piece of digital forensics evidence in the client application's (e.g., Examine) digital forensics datastore.

The generic data query is generic since the client digital forensics application may decide to upload a piece of text from an Artifact Hit. However, it could also be a piece of text from a Hit Fragment. For example, while a chat message may contain a message that is associated with the Hit, there may also be an image with text in it that has been run through an OCR (Optical Character Recognition which extracts text from an image) Model to extract the text and this text may be stored as a Hit Fragment with the text from the image. In both cases, the text is related to the same message. The client's digital forensics evidence store references the hit or fragment via the generic client ID. This approach decouples the system for generating artifact filters (e.g., a system implementing method 200) from the calling client application, so the two systems do not need to understand how each system stores and references data.

Referring now to FIG. 3, shown therein is a computer system 300 for reviewing target device digital evidence, according to an embodiment.

The system 300 may be configured to implement the method 100 of FIG. 1 and the method 200 of FIG. 2.

Components of the computer system 300 may be implemented at one or more devices, such as a server platform and a user device.

The system 300 includes a memory 310 and a processor 301 in communication with the memory 310.

The processor 301 is configured to execute various software modules and components. In some embodiments, modules or components executed by the processor 301 may include server-side software components and client-side software components that communicate with each other in order to provide various features and functionalities of the system 300. In some cases, server-side components may be executed at a server computer and client-side components may be executed at a user device.

The system 300 includes a communication interface device 390 for transmitting and receiving data to and from other computing devices. The communication interface device 390 may include a network interface device for transmitting and receiving data via a network connection (e.g., local area network, wide area network, etc.).

The system 300 includes a display device 360 for displaying data generated by the system 300. The display device 360 may be located at a user device.

The system 300 includes an input device 370 for receiving input data from a user interacting with the system 300. For example, a user may use input device 370 to interact with the system 300 through a graphical user interface generated by the processor 301 and displayed via the display device 360. The input device 370 may be located at the user device. A user may input information requests about a digital forensic investigation through input device 370.

The processor 301 executes an application for processing and viewing digital evidence of a target device.

The processor 301 is configured to execute a plurality of software modules or components including a user interface module 302, an investigation module 303, and an output module 304.

The user interface module 302 generates a graphical user interface for reviewing digital evidence. The GUI is displayed via the display device 360.

The investigation module 303 processes user commands, such as a user query, used to investigate digital evidence on a target device.

The output module 304 outputs digital evidence retrieved from the user query.

The memory 310 stores executable program data 350, domain parser schemas 320, filter parser schemas 330, and filter combiner 380.

The executable program data 350 includes instructions and data required to run the modules of processor 301.

The filter combiner 380 stores the intermediate results of the domain parser 320 and the filter parser 330. The filter combiner combines the results into a generic data query response returned to the processor 301.

The domain parser 320 stores natural language patterns for the supported domain schemas 321 that a user query may belong to. The domain parser 320 parses a user query into the supported domains 321 of the computer system 300.

The domain schemas 321 represent the structure of domain data described in a formal language supported by the database storage system.

The domain schema 321 includes an application schema 322, a numeric schema 323, a location schema 324, a date schema 325, an identifier schema 326, a keyword schema 327, and an unknown schema 328.

For example, a user's natural language query may be “could you please tell me what photos were taken within 100 miles of Ottawa, ON?”. In that sentence, the unknown schema 328 segment of the query would hold “could you please tell me”, which would not be used when building filters to limit the evidence used in the query. The “what photos were taken” would be the Application Schema 322 segment and “within 100 miles of Ottawa, ON” would be the Location 324 Schema segment.

The application schema 322 documents the content and the logical structure of application data.

The numeric schema 323 documents the content and the logical structure of numeric data.

The location schema 324 documents the content and the logical structure of location data.

The date schema 325 documents the content and the logical structure of date data.

The identifier schema 326 documents the content and the logical structure of identifier data.

The keyword schema 327 documents the content and the logical structure of keyword data.

The unknown schema 328 documents the content and the logical structure of unknown data. The Unknown Schema 328 is a catch all for any piece of the natural language query that does not map to a domain that can be used to help answer the question.

The filter parser 330 stores natural language patterns for the supported filter schemas 331 that can be used to filter digital evidence for a target device to the set of evidence that the investigator requests in the query.

The filter schema 331 includes the structure of filters described in a formal language support by the database storage system. In an embodiment, a filter is a program or section of software code that is designed to examine each input or output data.

The filter schema 331 includes an application filter set 332. The application filter set 332 includes a set of filters that belong to the application schema 322 domain.

The filter schema 331 includes an application group filter 333. The application group filter 333 is a filter that groups applications by a common family. Examples of application groups include storage, chats, media, location, peer to peer, social networking, web, email, documents, and the like.

The filter schema 331 includes a location filter set 334. The location filter set 334 includes a set of filters that belong to the location schema 324 domain. The filter set 334 includes location filter 335 and skin tone filter 344.

The filter schema 331 includes a location filter 335. The location filter 335 is a program of section of software code that is designed to examine each input or output location data.

The filter schema 331 includes a numeric filter set 336. The numeric filter set 336 includes a set of filters that belong to the number schema 323 domain. The numeric filter set 336 includes numeric filter 337 and skin tone filter 344.

The filter schema 331 includes a numeric filter 337. The numeric filter 337 is a program or section of software code that is designed to examine each input or output numeric data.

The filter schema 331 includes a date filter set 338. The date filter set 338 includes a set of filters that belong to the date schema 325 domain. The date filter set 338 includes data filter 339 and skin tone filter 344.

The filter schema 331 includes a date filter 339. The date filter 339 is a program or section of software code that is designed to examine each input or output date data.

The filter schema 331 includes an identifier filter set 340. The identifier filter set 340 is a set of filters the belong to the identifier schema 326 domain. The identifier filter set 340 includes identifier filter 341 and skin tone filter 344.

The filter schema 331 includes an identifier filter 341. The identifier filter 341 is a program or section of code that is designed to examine each input or output identifier data.

The filter schema 331 includes a keyword filter set 342. The keyword filter set 342 includes a set of filters that belong to the keyword schema 327 domain. The keyword filter set 342 includes keyword filter 343 and skin tone filter 344.

The filter schema 331 includes keyword filter 343. The keyword filter 343 is a program or section of software code that is designed to examine each input or output keyword data.

The filter schema 331 includes a skin tone filter 344. The skin tone filter 344 is a program or section of software code that is designed to examiner each input or output image data based on skin tone.

The filter schema 331 includes a media categorization filter 345. The media categorization filter 345 is a program or section of software code that is designed to examine each input or output image data based on media categorization.

The filter schema 331 includes an unknown filter 344. The Unknown Schema catches any segments of the user's natural language query that do not map to a filter that can be used to filter the digital forensics evidence to assist in answering the user's query.

Referring now to FIG. 4, shown therein is a data processing pipeline 400 for natural language inspection of artifact hits in a digital forensics system, according to an embodiment. The pipeline 400 may be used to identify relevant artifacts (or “hits”) in a target dataset under investigation and present a natural language summary of the output or findings of the search.

The pipeline 400 may be implemented by the computer system 300 of FIG. 3.

The pipeline 400 starts with a user prompt 402. The user prompt 402 describes or defines a user's investigative interests, or what the user would like the system to identify.

The user prompt 402 may be input by a user via an input device, such as input device 370 of FIG. 3. For example, the user may be presented with a user interface configured to receive a user prompt. In an embodiment, the user prompt 402 comprises an alphanumeric text string.

In an example, the user prompt 402 may be “summarize the user's browser search history on iPhone between October 7th and October 21st”. In another example, which may be related to the previous example, the user prompt 402 may be “is there any evidence of searches on how to make a bomb during this time”. The content and format of other possible user prompts 402 may vary and will be evident to a person of skill in the art.

The user prompt 402 is provided to an artifact filter generation module 404. The artifact filter generation module 404 is configured to receive the user prompt 402 as input and generate one or more artifact filters 406 as output.

The system may process many different types of artifacts that can be grouped into common artifact types. A simple grouping may be videos, images, audio, text, and chat.

The artifact filter 406 looks at the user's query from 402 and turns “any photos of” into an artifact filter for images.

The artifact filter 406 may be generated as described in method 200 of FIG. 2. The user query is segmented into high level domains. The high level domains are then turned into detailed filters. The detailed filters are used to filter the digital forensics evidence to find the evidence that best matches the user's query.

The artifact filter 406 functions to reduce the amount of digital forensics evidence that is searched when looking up evidence context to add to an LLM prompt to help answer the user's query.

In an example case, a user may ask a question such as “show me any images or videos that contain item X”. In response, there may be two artifact filters created: a first artifact filter to filter by videos and a second artifact filter to filter by images. So, in such a case, the filter created would be a filter to search for any video or image that matches the user's query. In the example case, this would be any video or image that contains “item X”.

While further reference to the one or more artifact filters 406 will refer to a single artifact filter 406, it is to be understood that the subsequent operations of the pipeline 400 may be applied to more than one artifact filter.

The artifact filter 406 is provided to an artifact hit filtering module 408.

The artifact hit filtering module 408 filters a target dataset 410 using the artifact filter 406. The artifact hit filtering module 408 generates filtered hits 412 as output. The filtered hits 412 include artifacts from the target dataset 410 that have been “filtered-in” by the artifact fit filtering module 408. The filtered hits 412 include artifacts that meet the criteria of the artifact filter 406.

The filtered hits 412 are provided to an NLP response generation module 414. The NLP response generation module 414 receives the filtered hits 412 as input and generates an NLP response and relevant artifact hit citations 416 as output.

The NLP response includes a natural language summary of what was found by the search. The natural language summary may be presented as text in a user interface.

The relevant artifact hit citations 416 include a list of citations to each artifact hit. In an embodiment, the relevant artifact hit citations 416 include a list of record IDs corresponding to a data record associated with the artifact hit. For example, for a web browser search history artifact hit, the citation may include a record ID including a uniform resource locator (URL) for the artifact.

In an example, an output to a question about images may contain citations that include a record ID of the image in the citation and text that is associated with the image. The text may be, for example, an image caption that describes the image or an image tag that indicates that the image has been classified as containing an item that is listed in the tag.

Another citation example may be for a chat. For a chat, the citation may include a Thread ID of the conversation that the message belongs to, the user name of the user that sent the message, the message that was used in the context to answer the question, and a client ID of the message in the client application's digital forensics evidence data store.

The citation is provided to the user so the user can see what fields were used from the digital forensics evidence to answer the query. The citation is also provided so the client application can provide a link to the original digital forensics evidence, enabling the user to verify the citation and look up any additional information from the digital forensics evidence that may not have been included in the citation.

Referring now to FIG. 5, shown therein is the artifact filter generation module 404 of FIG. 4 in further detail, according to an embodiment.

The artifact filter generation module 404 may be implemented by the investigation module 303 of FIG. 3.

The user prompt 402 of FIG. 4 is used to generate example filters 504.

When creating filters for a filter schema that is within a higher level domain schema, examples of the filter are provided to the LLM. The examples guide the LLM on creating the structured filter in the format desired for the filter. So, if example filters for a Date Filter are provided, an example would be provided of the natural language segment of the query (such as “within 2 weeks of May 15, 2024”) and then an example of how this filter would be defined. Multiple examples of each Filter schema are provided to help the LLM reason on how to convert the user's Natural Language Query into a structured filter.

The example filters 504 are used to generate filter schemas 506.

A domain schema is a high level segmentation of a query into domains. For example, a Numeric Domain Schema may include a Numeric Filter, a Skin Tone Filter, and a Media Categorization Filter.

The Domain Schema is the high level. The Filter Schema is the detailed description of the detailed schema for the segment. So, a segment such as “with skin tone percentage >50%” would be recognized as being part of the Numeric Domain. The Domain Schema and the segment of the query that matches the domain schema are generated on a first pass through the LLM.

On a second pass, the filter schema definitions that belong under the higher level domain schema are passed into the system along with the segment of text that is part of the higher level parent domain (Numeric Domain).

On this second pass, the LLM looks at the segment and the various filter schemas, picks the filter schemas that best represent the query segment, and then returns the filter that would be created from the query segment.

So, the query segment “with skin tone percentage >50%” would be converted into a Skin Tone Percentage Filter with a value of 51-100.

An example filter schema 506, according to an embodiment, will now be described.

The following is a schema for splitting a user query (or user prompt 402) into segments based on their meaning.

A segment should be matched to the domain that mostly closely captures the intent of the segment for further processing.

Enough of the segment must be preserved from the original user query so the segment can be used for further processing.

Filler words must not be included in the segment provided to each domain. Example filler words include “in the case”, “in the hits”, “in the evidence”, “with”, “in the data”, etc.

It is better to be accurate. If there is uncertainty, consider a domain to be known.

A filter domain may describe a data filter, an artifact filter, a numeric filter, a keyword filter, a location filter, or a digital identifier filter.

```
export interface FilterDomain {
  domains: (
    | DateFilterDomain
    | ArtifactFilterDomain
    | NumericFilterDomain
    | LocationFilterDomain
    | IdentifierFilterDomain
    | KeywordFilterDomain
    | UnknownFilterDomain
  )□;
}... etc ...
```

The artifact filter generation module 404 includes a large language model

(LLM) filter module 508.

The LLM filter module 508 receives filter schemas 506 as input and generates domain separated filter prompts 510 and artifact filter 512. In an example, domain separated filter prompts 510 may include:
Artifact: Internet Search
Date: Oct 7^{th}<=Oct 21^{st}
Source: iPhone 7

The input to the LLM filter module 508 is a natural language query and example filter generation outputs. The output of the LLM filter module 508 is a JSON structure that represents multiple filters in an application agnostic way.

The LLM filter module 508 is a series of proprietary prompts that are chained together programmatically to turn a natural language query into an application agnostic filter structure via an LLM. The LLM may be a commercial off-the-shelf LLM.

For the domain separated filter prompt 510, an input user query is broken apart into sections. The sections are called “domains”. Each domain represents a type of filtering operation that the system knows how to handle. This is done via the LLM and using a specialized prompt meant to segment the query into relevant pieces based on filters that are important.

For example: “User query=show me all pictures taken from June to July 2020”=>“Domains=‘show me all pictures’+‘from June to July 2020’.

For each of those domains, a prompt 510 is constructed that outlines how to convert the domain into a corresponding filter structure.

These prompts 510 are very specific to the domain (date range, for example), and are used to reliably convert natural language into a JSON structure.

These prompts 510 outline the fields within the data structure and tell the LLM what things to consider when it tries to extract the JSON structure from the statement.

The artifact filter 512 is the end result in the client digital forensics data processing application (e.g., Axiom). The client application takes the agnostic output JSON structure from the LLM Filter Module 508 and converts it into code that becomes a native filter in the client application.

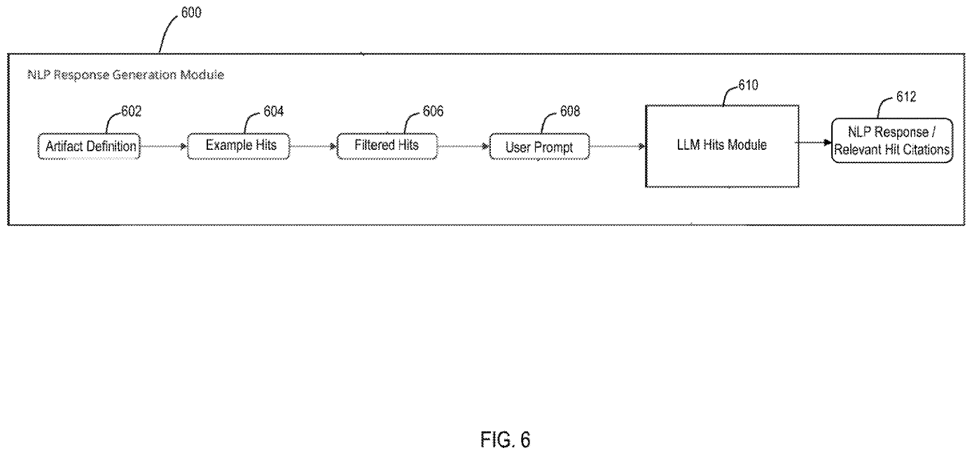

Referring now to FIG. 6, shown therein is the natural language processing (NLP) response generation module 414 of FIG. 4 in further detail, according to an embodiment.

The NLP response generation module 414 may be implemented by the investigation module 303 of FIG. 3.

The NLP response generation module 414 uses an artifact definition 602. An artifact definition 608 is used to pick what artifacts a query should be constrained to. For example, a natural language question asking about images will use the artifact definition 602 to look up the filter needed to filter all the digital forensics evidence to just evidence that is an image.

An example artifact definition 602 for a chrome web visit artifact, according to an embodiment, will now be described.

The artifact definition 602 may include a const definition]. The const definition is a construct that defines a variable as immutable. A const definition may include a name attribute and a description attribute. An example const definition is:
Const description=
**Name**: Chrome Web Visits
**Description**: Chrome Web Visits contains a history of the websites that the user visits (includes all visits).

The const description may include one or more fragment descriptions (associated fragments). Fragment descriptions may include a URL fragment description, a Title description, a Date Visited Date/Time description, a Typed Count description, a Transition Type description, and a Visit Source description. Example fragment descriptions for a Chrome Web Visits artifact is:
**Fragment descriptions**
*URL: The URL of the visited web page.
*Title: The title of the webpage that was visited.
*Date Visted Date/Time—UTC (yyyy-mm-dd): The date and time when the webpage was last visited.
*Typed Count: The number of times that the website was accessed by the user typing the URL (as opposed to clicking a link).
*Transition Type: Describes how the browser navigated to this URL. For example, if a user visits a page by clicking on a link on another page, the transition type is link.
*Visit Source: The source of that visit.

The artifact definition 602 is used to generate example hits 604.

Example hits are examples of the artifact type, what the hit context from the filtered hits will look like when provided in the user prompt, and an example of an answer that would be expected given the Example Hits.

The example hits 604 are used to generate filtered hits 606. The type of artifact is used to limit the hits to be used for context. Any filter schemas based on the user query are used to then refine the filter further. The closest matches are then returned by the filtered hits 606 and are taken and used in the user prompt.

The filtered hits 606 are used to generate a user prompt 608.

A user prompt 608 is a prompt that has been pre-tuned to answer a question for a specific type of query as it relates to an artifact type.

The prompt 608 is picked based on the artifact definition 602 being used. The example hits 604 are retrieved based on the artifact definition 602 that relates to the user's query. The filtered hits 606 are filtered from the digital forensics evidence based on the artifact definition 602. These are all then combined into the user prompt 608 before being sent to the LLM.

The user prompt 608 is provided to a large language model (LLM) hits module 610.

The hits module 610 puts the artifact definition 602, example hits 604, filtered Hits 606, and user prompt 608 together before the hits module 610 sends the user prompt 608 to the LLM in the LLM Hits Module 610. The LLM in the LLM hits module 610 generates the NLP Response and Relevant Hit Citations 612.

In an embodiment, more than one LLM is used in the LLM hits module 610. The LLM may be trained with large amounts of data from the internet. The LLMs in use may be commercial, pre-trained LLMs.

The LLM hits module 610 receives the user prompt 608 as input and generates an NLP response and relevant hit citations 612 as output. The NLP response and relevant hit citations 612 may be displayed in a user interface.

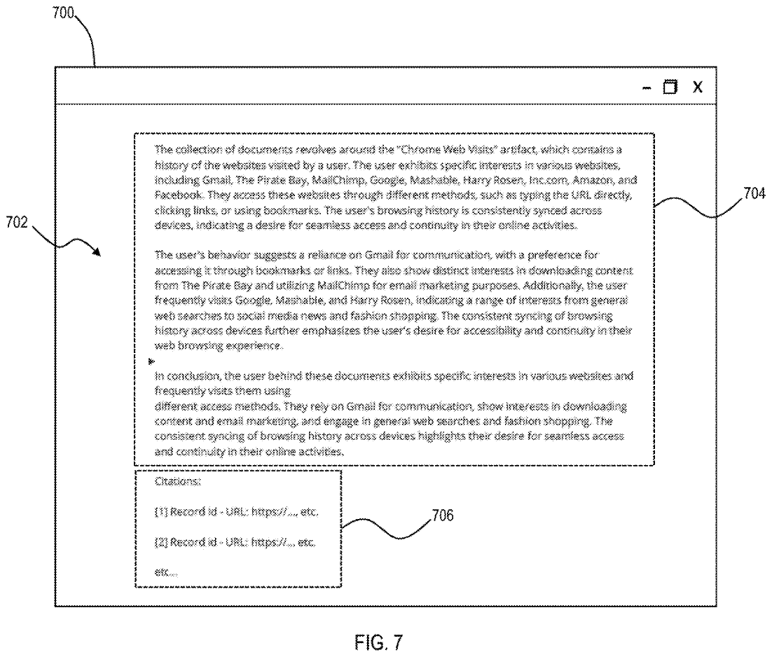

Referring now to FIG. 7, shown therein is an example graphical user interface screen 700 displaying an example output of the data processing pipeline 400 of FIG. 4, according to an embodiment.

The user interface 700 may be generated by user interface module 302 and displayed via display device 370 of FIG. 3.

The user interface 700 includes a visualization 702 of NLP response and relevant hit citations 612 of FIG. 6. The visualization 702 includes a NLP response visualization 704 and a relevant hit citations visualization 706. The visualizations 702, 704, 706 may be considered and referred to as user interface elements.

The NLP response visualization 704 includes a text summary describing an output or results of the investigation performed by the pipeline 400.

The NLP response 704 words the answer to the user's question in a human readable format. The NLP response 704 provides context to the citations 706 returned. For example, instead of returning 10 messages from various different chats that all contain words that are semantically related to “buying guns” (that the user must then read through), the user may get an NLP response 704 that says “there are 10 messages that discuss the purchase of guns. In one message, a user asks how they should transfer money to the seller to pick up a Glock. In another, a different user asks if the seller will take anything in place of money for the gun they are offering.” etc.

The NLP response 704 helps the user get better context from the query they submitted and the citations 706 that were used.

The relevant hit citations visualization 706 includes a list of record IDs corresponding to filtered hits 606. The filtered hits that were used for the context in the User Prompt 608 are used to build the Citations in 612. Only the filtered hits we used from 606 will be included in the Citations returned by 612.

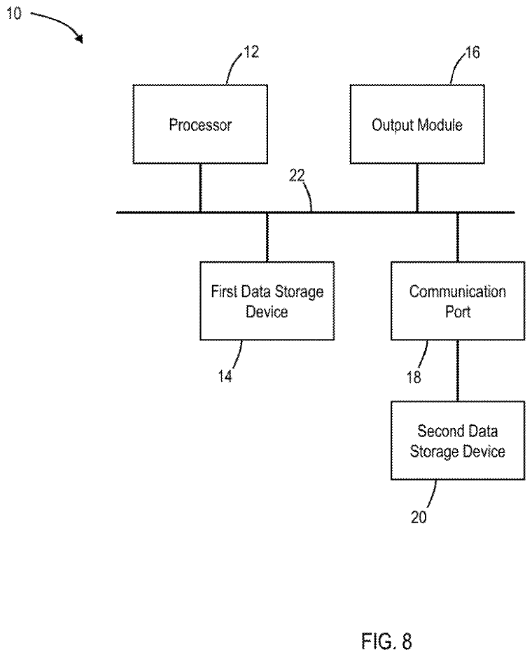

Referring now to FIG. 8, shown therein is a system 10 for natural language inspection of artifact hits in a digital forensics system, according to an embodiment.

The system 10 includes a processor 12, a first data storage device 14, an output module 16, a communication port 18 and a second data storage device 20 coupled to the communication port 20. In this embodiment, the various components 12, 14, 16, 18 of the system 10 are operatively coupled using a system bus 22.

The system 10 may be various electronic devices such as personal computers, networked computers, portable computers, portable electronic devices, personal digital assistants, laptops, desktops, mobile phones, smart phones, tablets, and so on.

In some examples, the first data storage device 14 may be a hard disk drive, a solid-state drive, or any other form of suitable data storage device and/or memory that may be used in various electronic devices. The data storage device 14 may have various data stored thereon. Generally, the data stored on the data storage device 14 includes data that may be of forensic value to a digital forensic investigation including forensic data extracted from one or more data storage devices of one or more investigation target devices. The forensic data may be organized according to investigation. The forensic data for a specific investigation may be referred to as “case data”. The forensic data includes forensic artifacts (“artifact hits”) extracted from a larger volume of forensic data (e.g., a forensic image or primary forensic dataset).

In the embodiment as shown, another data storage device in addition to the first data storage device 14, namely the second data storage device 20, is provided. The second data storage device 20 may be used to store computer-executable instructions that can be executed by the processor 12 to configure the processor 12 to perform natural language inspection of artifact hits stored in the data storage device 14 or of artifact hits acquired from the first data storage device 14 and stored in the second data storage device 20.

It should be noted that it is not necessary to provide a second data storage device, and in other embodiments, the instructions may be stored in the first data storage device 14 or any other data storage device.

In some cases, the first data storage device 14 may be a data storage device external to the system 10 or processor 12. For example, the first data storage device 14 may be a data storage component of an external computing device (e.g. a mobile phone or a laptop computer) that is being forensically investigated. Such device may be referred to as a “target device”. In such cases, the processor 12 may be configured to execute computer-executable instructions (stored in second data storage device 20) to acquire a forensic image of the first data storage device 14 and store the forensic image in the second data storage device 20.

The processor 12 may be configured to provide a user interface to the output module 16. The output module 16, for example, may be a suitable display device (e.g. a monitor) coupled to the processor 12. The user interface allows the processor 12 to solicit input from a user regarding various types of operations to be performed by the processor 12. The user interface also allows for the display of various output data and determinations, such as citations to relevant artifact hits and a natural language processing response characterizing results of the inspection, generated by the processor 12.

The system 10 may be a purpose-built machine designed specifically for conducting natural language inspection of artifact hits in a digital forensics system.

The system 10 may be a server computer, desktop computer, notebook computer, tablet, PDA, smartphone, or another computing device. The system 10 may include a connection with a network such as a wired or wireless connection to the Internet. In some cases, the network may include other types of computer or telecommunication networks. The system 10 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor 12 may execute applications, computer readable instructions or programs. The applications, computer readable instructions or programs may be stored in memory or in secondary storage or may be received from the Internet or other network. Input device may include any device for entering information into system 10. For example, input device may be a keyboard, keypad, cursor-control device, touchscreen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, system 10 may include multiple of any one or more of processors, applications, software modules, second storage devices, network connections, input devices, output devices, and display devices.

Although system 10 is described with various components, one skilled in the art will appreciate that the system 10 may in some cases contain fewer, additional or different components. In addition, although aspects of an implementation of the system 10 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the system 10 and/or processor 12 to perform a particular method.

In the description that follows, devices such as system 10 are described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, a user using the system 10 may manipulate one or more input devices (not shown; e.g. a mouse and a keyboard) to interact with a user interface displayed on a display of the system 10. In some cases, the system 10 may generate and/or receive a user interface from the network (e.g. in the form of a webpage). Alternatively, or in addition, a user interface may be stored locally at a device (e.g. a cache of a webpage or a mobile application).

In response to receiving information, the system 10 may store the information in storage database. The storage may correspond with secondary storage of the system 10. Generally, the storage database may be any suitable storage device such as a hard disk drive, a solid state drive, a memory card, or a disk (e.g. CD, DVD, or Blu-ray etc.). Also, the storage database may be locally connected with the system 10. In some cases, storage database may be located remotely from system 10 and accessible to system 10 across a network for example. In some cases, storage database may comprise one or more storage devices located at a networked cloud storage provider.

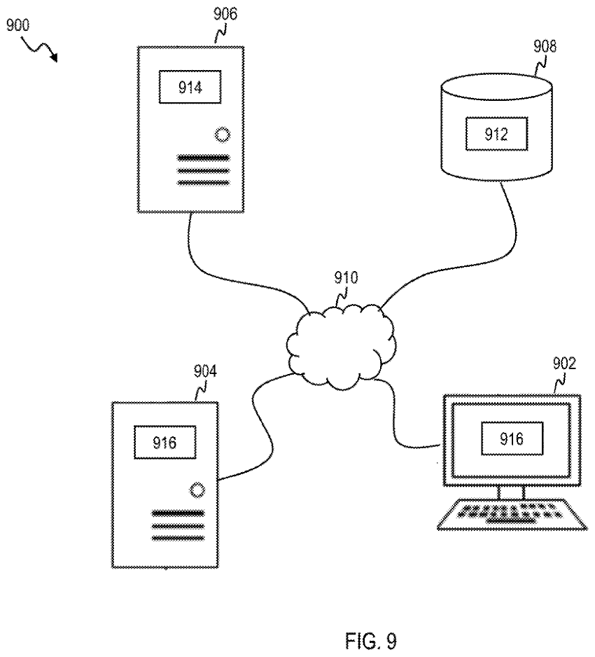

Referring now to FIG. 9, shown therein is a digital forensics system 900, according to an embodiment. The digital forensics system 900 may be used to implement any of the systems and methods described herein.

The system 900 includes an artificial intelligence (AI) server computer 902, a user device 904, a forensic data server computer 906, and a data storage device 908. The devices 902, 904, 906, 908 communicate via network connection 910.

The data storage device 908 stores a database 912 of forensic data extracted from one or more target devices under investigation (digital forensics evidence data store). The forensic data includes one or more forensic images extracted from the one or more target devices and digital forensic artifacts (artifacts, or artifact hits) extracted from the forensic images. The database 912 may be considered and referred to as an original source of forensic evidence (original forensic evidence).

The forensic data server 906 executes a digital forensics data processing application 914. By way of nonlimiting example, digital forensics data processing application 914 may be Magnet Forensics AXIOM Process or similar application . . . . The digital forensics processing application 914 is configured to extract forensic artifacts (i.e., identify artifact hits) within a primary forensic dataset (e.g., a forensic image of a target device) and store the extracted artifacts in the database 912 of the data storage device 908. The database 912 may thus be considered a digital forensics evidence store of the digital forensics data processing application 914. The digital forensics processing application 914 may be referred to herein as a “client application”, particularly in respect of the operation of artifact inspection application 916 (described below).

The system 900 further includes an artifact inspection application 916. The artifact inspection application 916 uses AI and natural language to inspect artifact hits. The artifact inspection application 916 executes partially at AI server 902 and partially at user device 904. For example, AI server 902 may execute server-side components of the application 916 and user device 904 may execute client-side components of the application 916. Generally, the application 916 is configured to inspect artifact hits in the database 912 based on a natural language input provided by a user at user device 904. The application 916 processes the natural language input, inspects the database 912 to identify relevant artifact hits, and outputs the relevant artifact hits to the user device 904 for display to a user.

1. A method of searching a digital forensic evidence data store in a data storage device, the method executed by one or more processors in communication with the data storage device, the method comprising:
receiving a user query from a user in natural language via a graphical user interface;
generating an artifact filter from the user query using retrieval augmented generation (RAG);
searching the digital forensic evidence data store using the artifact filter to find artifacts that are semantically relevant to the user query; and
displaying the found artifacts in the graphical user interface.

2. The method of claim 1, further comprising generating a natural language response to the user query based on the found artifacts using a large language model (LLM) and displaying the natural language response with the found artifacts.

3. The method of claim 1, wherein the found artifacts are displayed as structured data citations.

4. The method of claim 2, wherein the structured data citations each include a link to original digital forensic evidence in the digital forensic evidence data store corresponding to the artifact.

5. The method of claim 1, wherein generating the artifact filter includes generating generic data query steps and transforming the generic data query steps into an application-specific filter structure, and wherein searching the digital forensic evidence data store using the artifact filter includes executing the application-specific filter structure against the digital forensic evidence data store.

6. A system of searching a digital forensic evidence data store in a data storage device, the system comprising:
a memory comprising at least one storage device;
one or more processors in communication with the memory, the one or more processors configured to:
receive a user query from a user in natural language via a graphical user interface;
generate an artifact filter from the user query using retrieval augmented generation (RAG);
search the digital forensic evidence data store using the artifact filter to find artifacts that are semantically relevant to the user query; and
display the found artifacts in the graphical user interface.

7. The system of claim 6, wherein the one or more processors are further configured to generate a natural language response to the user query based on the found artifacts using a large language model (LLM) and display the natural language response with the found artifacts.

8. The system of claim 6, wherein the found artifacts are displayed as structured data citations.

9. The system of claim 7, wherein the structured data citations each include a link to original digital forensic evidence in the digital forensic evidence data store corresponding to the artifact.

10. The system of claim 6, wherein generating the artifact filter includes generating generic data query steps and transforming the generic data query steps into an application-specific filter structure, and wherein searching the digital forensic evidence data store using the artifact filter includes executing the application-specific filter structure against the digital forensic evidence data store.

11. A digital forensics system comprising:
a data storage device; and
a processor in communication with the data storage device, the processor comprising:
a digital forensics data processing application configured to extract forensic artifacts from a primary forensic dataset and store the forensic artifacts in a database in the data storage device; and
an artifact inspection application configured to (i) receive a natural language query from a user through a user interface requesting inspection of the forensic artifacts, (ii) inspect the database based on the natural language query to identify relevant forensic artifacts from the forensic artifacts in the database using retrieval augmented generation (RAG), and (iii) output the relevant forensic artifacts for display in the user interface.

12. The system of claim 11, wherein inspecting the database includes converting the user prompt into an artifact filter using an artifact filter generation module comprising a large language model (LLM), and wherein the artifact filter is used by an artifact filtering module of the digital forensics data processing application to obtain the relevant forensic artifacts from the database.

13. The system of claim 11, wherein the artifact inspection application uses a first large language model (LLM) to generate an artifact filter from the user query for filtering the relevant forensic artifacts from the forensic artifacts and a second LLM to generate a natural language response to the user query based on the relevant artifacts.

14. The system of claim 13, wherein the artifact inspection application displays the relevant artifacts and the natural language response in the user interface.

15. The system of claim 11, wherein the artifact inspection application uses a large language model to generate a set of structured generic data queries from the user query, and wherein the digital forensics data processing application transforms the set of structured generic data queries into an application-specific filter structure for searching the database and executes the application-specific filter structure against the database to obtain the relevant forensic artifacts.

16. The system of claim 11, wherein the artifact inspection application creates a large language model (LLM) prompt to deconstruct the user query into relevant artifact domains that are further processed against domain schema.

17. The system of claim 11, wherein inspecting the database includes converting the user prompt into an artifact filter using a large language model (LLM), wherein the artifact filter includes a set of structured generic data queries and an application specific filter structure, wherein the artifact inspection application transforms the set of structured generic data queries into the application specific filter structure, and wherein the digital forensics data processing application executes the application specific filter structure against the database to obtain the relevant forensic artifacts.

18. The system of claim 11, wherein the inspecting the database includes using a large language model (LLM) to extract a set of generic data queries that correspond to the user query.

19. A non-transitory computer-readable medium storing computer-executable instructions, the instructions when executed by a computer processor for causing the computer processor to:
receive a user query from a user in natural language via a graphical user interface;
generate an artifact filter from the user query using retrieval augmented generation (RAG);
search the digital forensic evidence data store using the artifact filter to find artifacts that are semantically relevant to the user query; and
display the found artifacts in the graphical user interface.
